(19) United States
(12) Patent Application Publication
(10) Pub. No.: US 2022/0405670 A1
(43) Pub. Date: Dec. 22, 2022

(54) SYSTEM AND METHOD FOR UPSTREAM INTERPARTY COMPONENT SUPPLY CHAIN CONTROL

(71) Applicant: Nidec Motor Corporation, St. Louis, MO (US)

(72) Inventors: Liming Zhou, Chesterfield, MO (US); Mark D. Weisheit, Hoffman Estates, IL (US); Prudencio Roque, III, Quezon City (PH); John Paul Fernandez, Laguna (PH)

(73) Assignee: Nidec Motor Corporation, St. Louis, MO (US)

(21) Appl. No.: 17/842,133

(22) Filed: Jun. 16, 2022

Related U.S. Application Data
(60) Provisional application No. 63/212,133, filed on Jun. 18, 2021.

(51) Int. Cl. G06Q 10/06

(52) U.S. Cl. CPC G06Q 10/06315

(57) ABSTRACT

A computer-implemented method for interparty component supply chain control that includes accessing, at a computing system operated on behalf of a downstream production entity, a database containing supplied part substance data relating a substance contained in a component part to a governmental restriction. The method includes generating, at the computing system of the downstream production entity, an electronic message describing performance of an action by a further downstream entity to be taken on or relative to the component part based on the governmental restriction, and transmitting the electronic message to a computing system operated on behalf of the further downstream entity.

### RELATED APPLICATIONS

This patent application claims priority to identically-titled U.S. Patent Application No. 63/212,133, filed Jun. 18, 2021, the entire contents of which are hereby incorporated herein by reference.

### FIELD OF THE INVENTION

The present disclosure generally relates to computer-implemented methods, systems comprising computer-readable media, and electronic devices for controlling supply chains between upstream and downstream parties.

### BACKGROUND

Existing methods of supply chain control of parts/components may be used to enable downstream actors (such as a producer of products) to access parts/components from upstream actors (part/component suppliers). Existing methods may also enable upstream actors to determine where upstream parts/components are distributed.

However, existing methods of supply chain control of parts/components and products presently do not enable downstream actors to fully take advantage of direct feedback from upstream actors.

This background discussion is intended to provide information related to the present invention which is not necessarily prior art.

### BRIEF SUMMARY

The following brief summary is provided to indicate the nature of the subject matter disclosed herein. While certain aspects of the present invention are described below, the summary is not intended to limit the scope of the present invention. Embodiments of the present invention provide technology and systems for secure and real-time interparty control over the movement and use of parts/components and finished products based on direct feedback from upstream suppliers detailing, for example, previously unidentified prohibited substances contained in such parts/components.

A first aspect of the present invention concerns a computer-implemented method for interparty component supply chain control. The computer-implemented method includes, via one or more transceivers and/or processors, accessing, at a computing system operated on behalf of a downstream production entity, a database containing supplied part substance data relating a substance contained in a component part to a governmental restriction. The method includes generating, at the computing system of the downstream production entity, an electronic message describing performance of an action by a further downstream entity to be taken on or relative to the component part based on the governmental restriction, and transmitting the electronic message to a computing system operated on behalf of the further downstream entity.

A second aspect of the present invention concerns non-transitory computer-readable storage media having computer-executable instructions stored thereon for interparty component supply chain control. When executed by at least one processor, the computer-executable instructions cause the at least one processor to access, at a computing system operated on behalf of a downstream production entity, a database containing supplied part substance data relating a substance contained in a component part to a governmental restriction. The computer-executable instructions further cause the at least one processor to generate, at the computing system of the downstream production entity, an electronic message describing performance of an action by a further downstream entity to be taken on or relative to the component part based on the governmental restriction, and transmit the electronic message to a computing system operated on behalf of the further downstream entity.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 illustrates an exemplary environment in which embodiments of a system may be utilized for upstream interparty component supply chain control;

FIGS. 2-5 illustrate various components of exemplary computer systems shown in block schematic form that may be used with the system of FIG. 1;

FIG. 6 is a flowchart of at least a portion of the steps of an exemplary computer-implemented method for upstream interparty component supply chain control;

FIGS. 7A and 7B are flowcharts illustrating in additional detail at least a portion of the steps of exemplary computer-implemented methods for performing the method of FIG. 6;

FIGS. 8A and 8B are flowcharts illustrating in additional detail at least a portion of the steps of exemplary computer-implemented methods for performing the method of FIG. 6; and

FIG. 9 is a flowchart illustrating in additional detail at least a portion of the steps of exemplary computer-implemented methods for performing the method of FIG. 6.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Existing methods of supply chain control of parts/components and products presently do not enable downstream actors (such as producers of products) to fully take advantage of direct feedback from upstream actors (such as part/component suppliers). Embodiments of the present invention provide technology and systems for secure and real-time interparty control over the movement and use of parts/components and products based on direct feedback from upstream suppliers detailing, for example, previously unidentified prohibited substances contained in such parts/components.

In one or more embodiments, such real-time control is achieved by linking computer systems operating on behalf of functionally isolated juristic entities, such as by linking downstream production entity databases and computer systems with upstream supplier databases and computer systems. In one or more embodiments, such linking may be achieved by linking respective entities' servers (for example, those operating under Applicability Statement 2 (AS2), File Transfer Protocol Secure (FTPS) or similar protocols) according to direct electronic data interchange (direct electronic data interchange (EDI)) methodologies, by linking respective entities' servers via interposed application programming interfaces (APIs), or according to other technologies for securely, quickly, and automatically exchanging structured data between databases hosted on different secure networks or systems.

A computer system “operating on behalf of” a juristic entity comprises one or more computing devices operating alone or as part of one or more computer networks under the direction and control of the entity, including computer systems owned by the entity or owned or operated by third party service providers and hosts under the direction and for the benefit of the entity. In one or more embodiments, a computer system operating on behalf of a downstream production entity is not operating on behalf of an upstream part/component supplier, and vice versa. This relationship may be established between a single downstream production entity and multiple upstream suppliers. In one or more embodiments a computer system that is not operating on behalf of an entity may not be lawfully accessed by the entity for its business purposes except in the discretion of another, independent entity.

One skilled in the art will appreciate that several terms may be used interchangeably herein to refer to the same element. For example, an “upstream supplier”, a “supplier entity,” and “supplier” may refer to the same thing. In another example, a “downstream finished production entity,” a “downstream production entity”, a “producer entity”, and a “producer” may also refer to the same thing. It should also be noted that a “finished” product may be one that is incorporated into still another assembly (for example, by a further downstream entity) prior to consumer sale without departing from the spirit of the present invention. In yet another example, “supplier part substance data,” and “substance data” may also refer to the same thing. In still another example, the terms “structured data survey,” “survey,” and “data survey” may also refer to the same thing. Reference to one term that is being used interchangeably with another term should not be taken in a limiting sense for any of the interchangeable terms.

Specific embodiments of the technology will now be described in connection with the attached drawing figures. The embodiments are intended to describe aspects of the invention in sufficient detail to enable those skilled in the art to practice the invention. Other embodiments can be utilized, and changes can be made without departing from the scope of the present invention. The following detailed description is, therefore, not to be taken in a limiting sense. The scope of the present invention is defined only by the appended claims, along with the full scope of equivalents to which such claims are entitled.

### Exemplary System

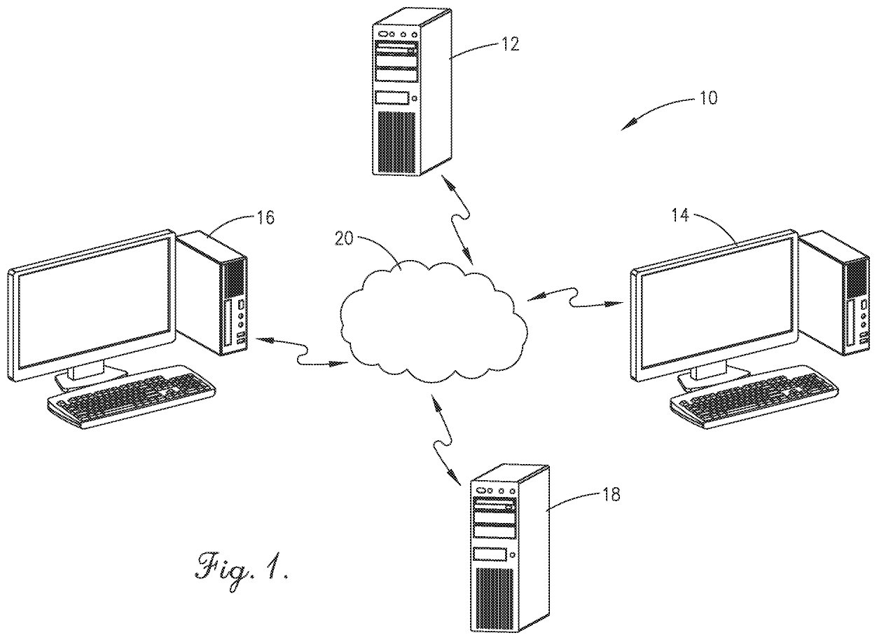

FIG. 1 illustrates an exemplary representation of an environment in which embodiments of a system 10 may be utilized for upstream interparty component supply chain control. The system 10 may include a first computer system 12 operating on behalf of an upstream part/component supplier entity, a second computer system 14 operating on behalf of a downstream production entity, a third computer system 16 operating on behalf of a production facility division of the downstream production entity, a fourth computer system 18 operating on behalf of a warehouse facility division of the downstream production entity, and a network 20 accessible by the computer systems 12, 14, 16, 18.

It should also be noted that the third and/or fourth computer systems 16, 18 may alternatively be operated on behalf of a further downstream entity that is, in turn, supplied with the product(s) of the downstream production entity for incorporation into and/or assembly with other product(s). In this manner, requests for supplier part substance data may issue from, and/or actions to be taken on or with respect to a part, component or product (described in more detail below) may be taken by, such a further downstream entity within the scope of the present invention.

The computer systems 12, 14, 16, 18 may be embodied by one or more application servers, database servers, file servers, mail servers, print servers, web servers, desktop computers, laptop computers, smart phones or other computing devices, or combinations thereof. Furthermore, the computer systems 12, 14, 16, 18 may include a plurality of servers, virtual servers, or combinations thereof. The computer systems 12, 14, 16, 18 may be configured to include or execute computer programs and software such as file storage applications, database applications, email or messaging applications, web server applications, or the like, in addition to and/or in conjunction with the computer program and/or software described elsewhere herein.

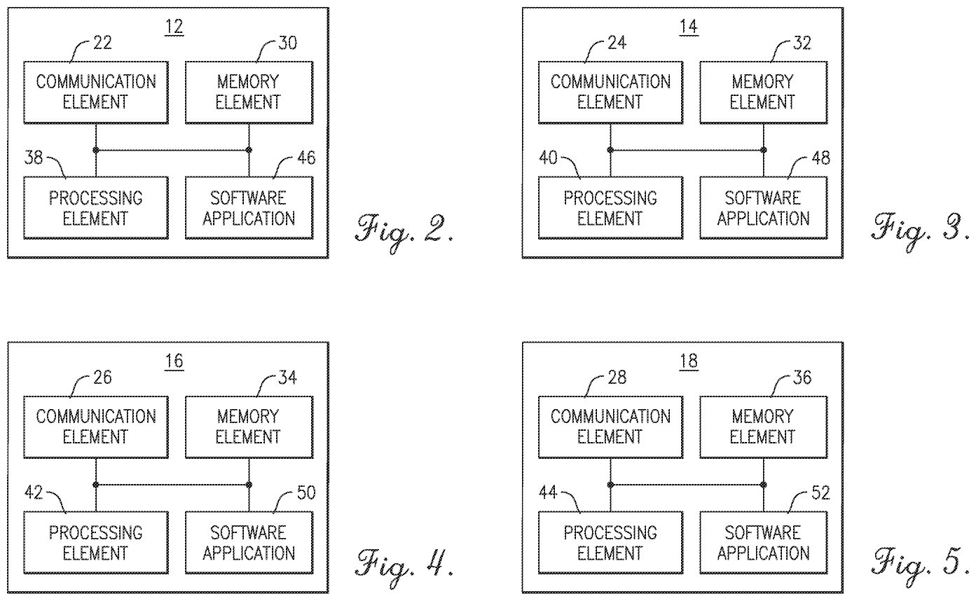

The computer systems 12, 14, 16, 18 may include communication elements 22, 24, 26, 28, memory elements 30, 32, 34, 36, and processing elements 38, 40, 42, 44 executing software applications 46, 48, 50, 52, as depicted in FIGS. 2-5. The communication elements 22, 24, 26, 28 generally allow communication with external systems or devices (such as via the network 20) and/or between the computer systems 12, 14, 16, 18.

The communication elements 22, 24, 26, 28 may include signal or data transmitting and receiving circuits, such as antennas, transceivers, amplifiers, filters, mixers, oscillators, digital signal processors (DSPs), and the like. The communication elements 22, 24, 26, 28 may establish communication wirelessly by utilizing RF signals and/or data that comply with communication standards such as cellular 2G, 3G, 4G, 5G, or LTE, IEEE 802.11 standard such as WiFi, IEEE 802.16 standard such as WiMAX, Bluetooth®, or combinations thereof. Alternatively, or in addition, the communication elements 22, 24, 26, 28 may establish communication through connectors or couplers that receive metal conductor wires or cables which are compatible with networking technologies such as ethernet. In certain embodiments, the communication elements 22, 24, 26, 28 may also couple with optical fiber cables. The communication elements 22, 24, 26, 28 may be in communication with or electronically coupled to their respective memory elements 30, 32, 34, 36 and/or processing elements 38, 40, 42, 44.

The memory elements 30, 32, 34, 36 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In one or more embodiments, the memory elements 30, 32, 34, 36 may be embedded in, or packaged in the same package as, their respective processing elements. Each of the memory elements 30, 32, 34, 36 may include, or may constitute, a “computer-readable medium.” The memory elements 30, 32, 34, 36 may store the instructions, code, code segments, software, firmware, programs, applications, apps, services, daemons, or the like that are executed by their respective processing elements 38, 40, 42, 44, such as, for example, respective software applications 46, 48, 50, 52.

The processing elements 38, 40, 42, 44 may include electronic hardware components such as processors. The processing elements 38, 40, 42, 44 may include electronic hardware components such as digital processing units. The processing elements 38, 40, 42, 44 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing elements 38, 40, 42, 44 may generally execute, process, or run instructions, code, code segments, software, firmware, programs, applications, apps, processes, services, daemons, or the like. The processing elements 38, 40, 42, 44 may also include hardware components such as finite-state machines, sequential and combinational logic, and other electronic circuits that may perform the functions necessary for the operation of the current invention. The processing elements 38, 40, 42, 44 may be in communication with the other electronic components through serial or parallel links that include address busses, data busses, control lines, and the like. The processing elements 38, 40, 42, 44 may be in electronic communication with their respective communication elements 22, 24, 26, 28 and memory elements 30, 32, 34, 36.

The network 20 may generally allow communication between the computer systems 12, 14, 16, 18. The network 20 may include local area networks, metro area networks, wide area networks, cloud networks, the Internet, cellular networks, plain old telephone service (POTS) networks, and the like, or combinations thereof. The network 20 may be wired, wireless, or combinations thereof and may include components such as modems, gateways, switches, routers, hubs, access points, repeaters, towers, and the like.

The first computer system 12 may operate on behalf of the upstream part/component supplier entity and is configured to operate as or in conjunction with a data management system that provides user and/or data exchange interface(s) for collection of structured data, and that manages access to and transmission of the data. As noted above, in one or more embodiments the first computer system 12 comprises at least one server (for example, operating under AS2, FTPS or similar protocols) linked to the second computer system 14 according to direct EDI methodologies or the like for securely, quickly, and automatically exchanging the structured data stored by the first computer system 12. It should also be noted that the second computer system 14 may be linked to multiple other isolated upstream part/component supplier entities implementing respective computer systems under the same or different protocols, in accordance with and without departing from the systems and methods described herein.

The first computer system 12 may receive, via its communication element 22 and/or via a user interface, data related to the presence or absence of prohibited or restricted substances contained in parts/components supplied by the supplier entity to the downstream production entity (“Supplied Part Substance Data”). For example, the data management system of the first computer system 12 may comprise a database—such as, but not limited to, a relational database—configured to store records linking part identification information (such as unique part identifiers and descriptive information) to Supplied Part Substance Data. The Supplied Part Substance Data may be received from independent, contracted and/or internal laboratories or testing facilities. The Supplied Part Substance Data may be obtained in response to a survey received from the second computer system 14 of the downstream production entity, as discussed below, or in connection with independent investigations of the upstream part/component supplier entity.

The first computer system 12 may be configured to receive via its communication element 22, such as over the network 20, requests for the Supplied Part Substance Data from the second computer system 14. In one or more embodiments, the requests take the form of a structured data survey including corresponding unique part identifiers and/or descriptive information and defining the requested Supplied Part Substance Data. The requested Supplied Part Substance Data may be defined, at least in part, based on applicable or potentially applicable laws. For example, the Supplied Part Substance Data may be defined at least in part by the requirements and definitions set forth in the Toxic Substances Control Act in the United States, as amended by the Frank R. Lautenberg Chemical Safety for the 21st Century Act (15 U.S.C. ch. 53 §§ 2601-2629) (the “TSCA”). More particularly, rules promulgated by the Environmental Protection Agency under § 6(h) of the TSCA may define the following as persistent, bioaccumulative and toxic (PBT) and, therefore, subject to prohibitions and/or governmental restrictions under the TSCA: decabromodiphenyl ether (DecaBDE); phenol, isopropylated phosphate (3:1) (PIP (3:1)); 2,4,6-Tris(tert-butyl)phenol (2,4,6-TTBP); hexachlorobutadiene (HCBD); and pentachlorothiophenol (PCTP).

The survey from the second computer system 14 may request information comprising Supplied Part Substance Data in a structured data format regarding the presence or absence of such PBTs to be or that have been delivered by the supplier entity. In one or more embodiments, the Supplied Part Substance Data is delivered via direct EDI between the first computer system 12 and the second computer system 14. For example, a monitoring module of the first computer system 12 may detect entry or receipt of the Supplied Part Substance Data in a record of the supplier's database flagged as relating to an active survey request from the downstream second computer system 14 of the downstream production entity. The first computer system 12 may, accordingly, periodically, or continuously transmit Supplied Part Substance Data of such records to the second computer system 14 via, for example, direct EDI.

In turn, the second computer system 14 may receive Supplied Part Substance Data from the first computer system 12, such as in response to its corresponding structured data survey. In one or more embodiments, a data management system of the second computer system 14 may comprise a database—such as, but not limited to, a relational database—configured to store records linking part identification information (such as unique part identifiers and descriptive information) to Supplied Part Substance Data. Received Supplied Part Substance Data may be stored in the database of the second computer system 14 upon receipt from the first computer system 12. In connection with retrieving Supplied Part Substance Data, the second computer system 14 may provide login credentials, access tokens, or similar authentication means to the first computing system 12, enabling access to request one or more data entries associating one or more of the unique part identifiers with Supplied Part Substance Data that has been mapped to a governmental restriction in the second computer system 14.

In addition, the data management system of the second computer system 14 may be configured with a monitoring module that detects new or revised records including Supplied Part Substance Data. In one or more embodiments, the data management system of the second computer system 14 is configured to detect new or revised Supplied Part Substance Data, to access related records corresponding to the implicated unique part identifier of the new/revised record, and to identify third and fourth computer systems 16, 18 using the accessed related records as potentially impacted by the new or revised Supplied Part Substance Data. For example, where the new or revised Supplied Part Substance Data indicates the presence of one or more PBTs in a part or component identified with a unique part identifier in a first record, the unique part identifier may be used to locate and access a second, related record that describes the third and fourth computer systems 16, 18—respectively corresponding to production and warehouse facility databases of the downstream production entity or a further downstream entity—as being responsible for managing data relating to production and storage of parts/products comprising or incorporating the implicated part or component containing one or more PBTs. In the same example, the data management system of the second computer system 14 may map the Supplied Part Substance Data obtained from the first computing system 12 to the corresponding governmental restriction.

The first computer system 12 may be configured to provide login credentials or other authentication means enabling access for the second computer system 14 to upload data regarding one or more restrictive measures to be taken relative to existing inventory related to the Supplied Part Substance Data.

The second computer system 14 may automatically transmit product hold and/or label application instructions to the third and fourth computer systems 16, 18, as described in more detail below and in the Figures. In one or more embodiments, components manufactured or produced prior to a given date will receive hold flags within the databases of the third and fourth computer systems 16, 18 unless and until conforming labels are applied to the implicated part(s), component(s) and/or finished product(s). In one or more embodiments, components manufactured or produced after the given date will receive hold flags within the databases of the third and fourth computer systems 16, 18 indefinitely.

One of ordinary skill will appreciate that where a part or component containing one or more PBTs is identified according to processes outlined herein, “hold” flags and/or conforming labels may be applied to any product or part that contains or relies on that part or component as determined, for example, by bill of material (BOM) or similar information accessible to any of the computer systems 12, 14, 16, 18 and relating products to its components. In addition, any of the computer systems 12, 14, 16, 18 may automatically generate a notification to one or more further downstream entities (such as customers) describing the part, component and/or finished product(s) impacted by detected presence of one or more PBTs.

Embodiments of the present invention therefore provide technology and systems for secure and real-time interparty control over the movement and use of parts/components and finished products based on direct feedback from upstream suppliers detailing, for example, previously unidentified prohibited substances contained in such parts/components.

The system may include additional, less, or alternate functionality and/or device(s), including those discussed elsewhere herein.

### Exemplary Method

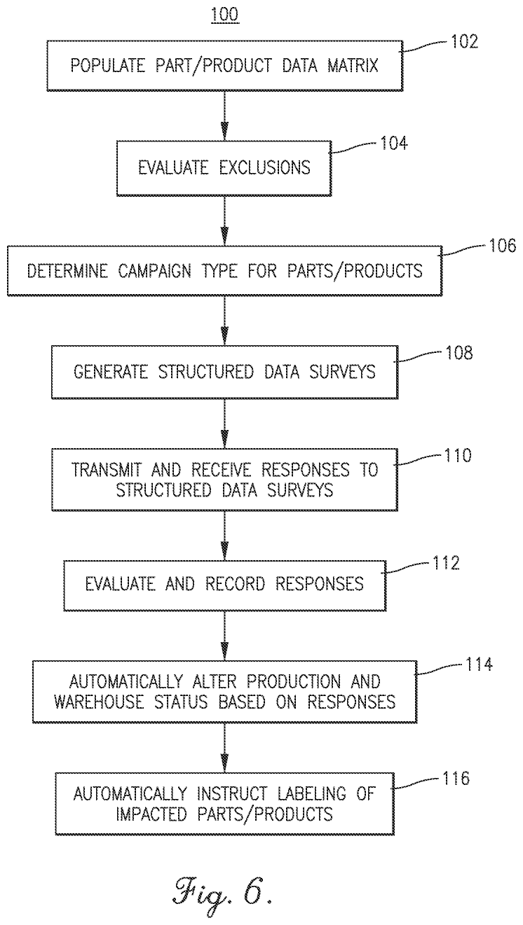

FIG. 6 depicts a listing of steps of an exemplary computer-implemented method 100 for upstream interparty component supply chain control. The steps may be performed in the order shown in FIG. 6, or they may be performed in a different order. Furthermore, some steps may be performed concurrently as opposed to sequentially. In addition, some steps may be optional.

The computer-implemented method 100 is described below, for ease of reference, as being executed by exemplary devices and components introduced with the embodiments illustrated in FIGS. 1-5. For example, the steps of the computer-implemented method 100 may be performed by the computers 12, 14, 16, 18 and the network 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. For example, the computer systems 14, 16, 18 may be collapsed into fewer or one server and/or database and/or database management system(s) and/or actions attributable to any of the foregoing may be alternatively distributed thereamong without departing from the spirit of the present invention.

One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

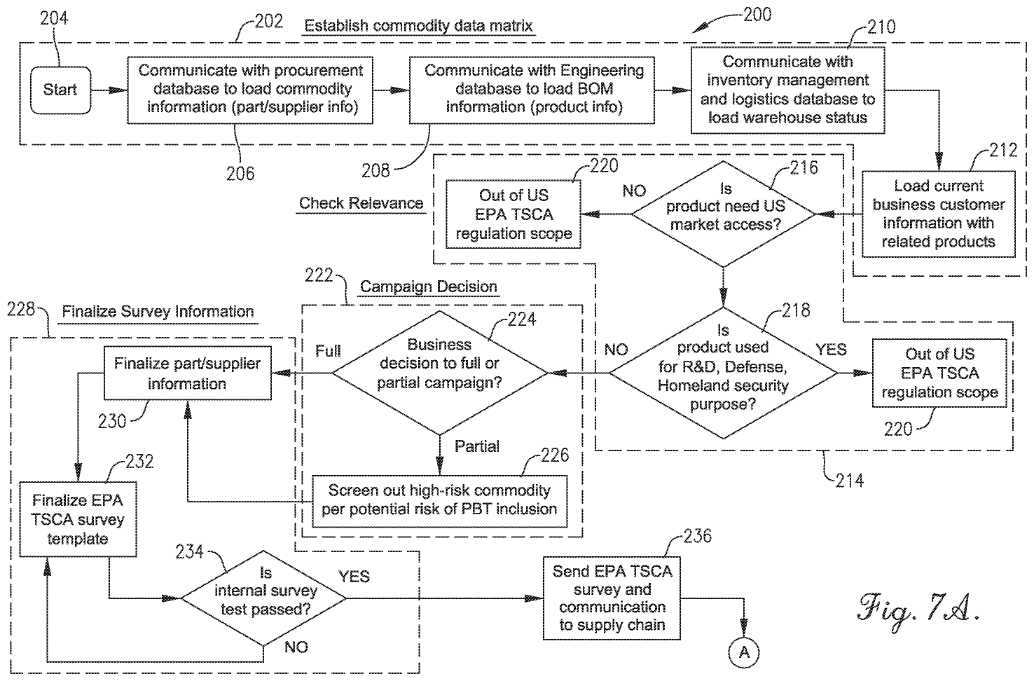

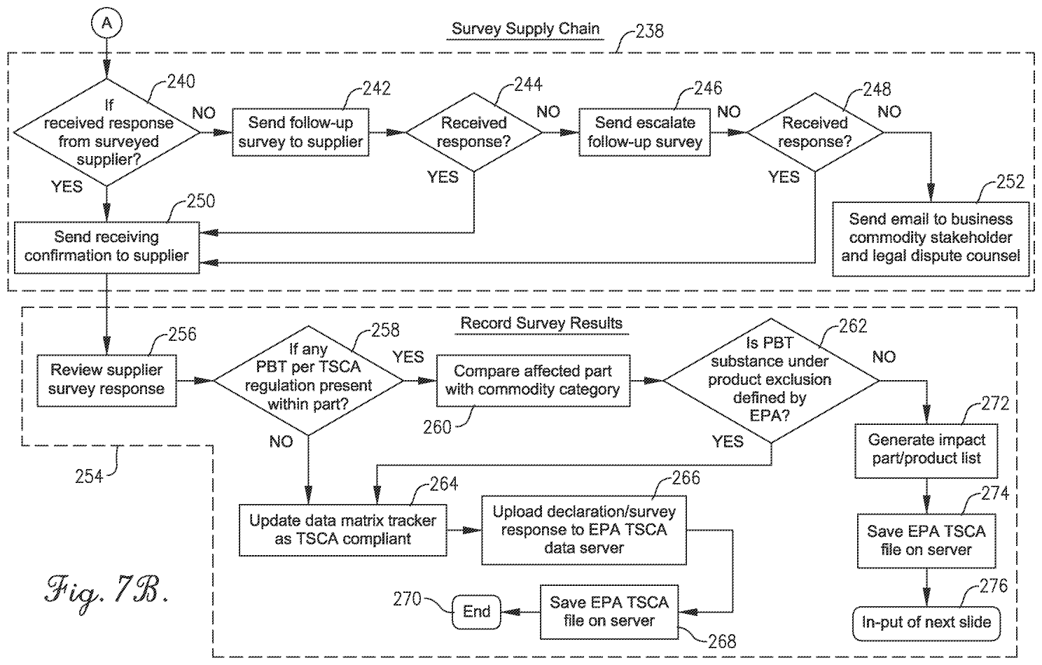

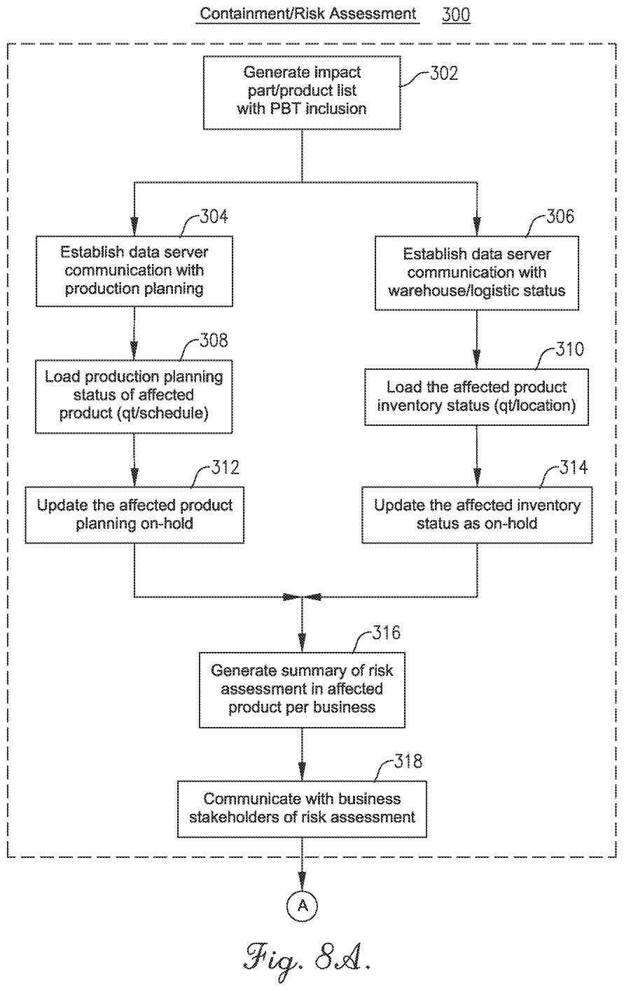

Referring to step 102, a part/product data matrix may be populated. In one or more embodiments, a processor executing a database management system on a server of a downstream production entity populates and manages revisions to the part/product (or commodity) data matrix to include the information outlined in method 200 discussed in more detail below for each part and product handled or produced by the downstream production entity. As noted in FIGS. 7A and 7B, such data may be sent to and/or received from engineering, inventory management and/or logistics and procurement databases of the downstream production entity, for example via a communication element of the server. In addition, the data may be accessed by a computing system operated on behalf of the supplier entity or a computing system of the downstream production entity. These other databases of the downstream production entity may themselves be managed by one or more additional database management systems hosted on one or more additional servers within the scope of the present invention.

Referring to step 104, exclusions may be evaluated for one or more (and preferably all) of the parts and products represented in the data matrix. For example, the processing element of the server of the downstream production entity may execute an algorithm and/or one or more rules for determining whether each part/product is or will be located in a geographical territory triggering compliance requirements under the TSCA and/or determining whether the part/product is to be used in a manner or for a purpose that brings it outside such compliance requirements. (FIG. 7B) Parts, components or products that are subject to exclusions may be flagged so as to avoid one or more of the survey and evaluation steps that follow.

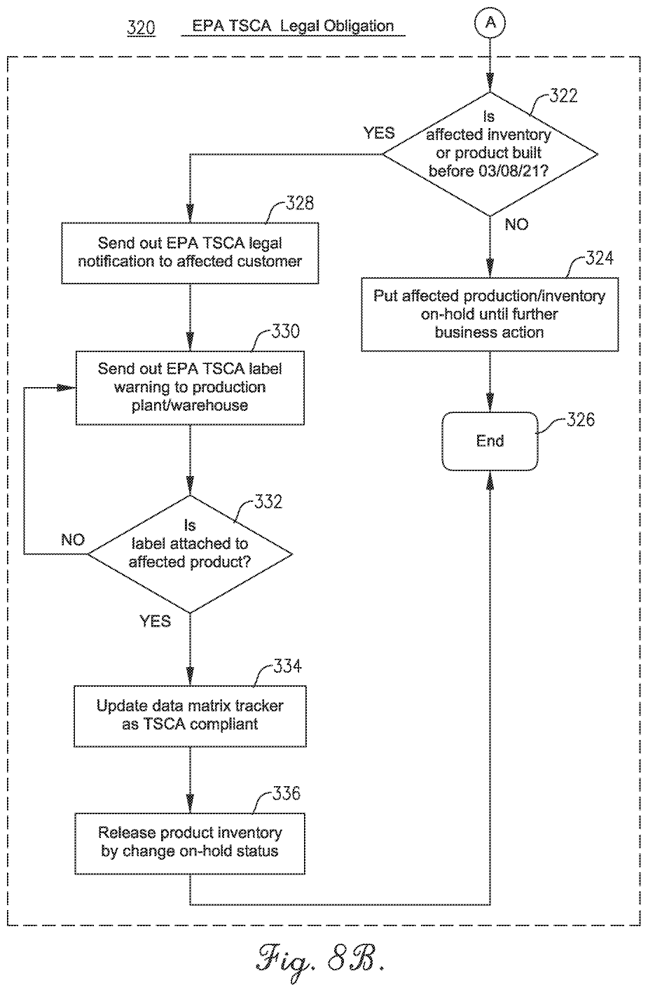

Referring to step 106, a campaign type may be determined for one or more of the parts and products. In one or more embodiments, each part/product that is not determined to be excluded under step 104 is evaluated by the processing element of the server of the downstream production entity according to an algorithm and/or one or more rules to determine whether it is or may be “high risk,” for example under applicable or potentially applicable governmental restrictions represented in the database managed by the downstream production entity. For example, categories of parts/products may be pre-determined as likely to include PBTs (see FIG. 8), and if the algorithm determines that a part/product falls into one of such categories it may be flagged for treatment as “high risk.”

Referring to step 108, structured data surveys may be generated. In one or more embodiments, the processing element of the server of the downstream production entity may execute an algorithm comprising, for example, a decision tree or complex set of business rules, to determine which suppliers should receive a structured data survey based on BOM information and the campaign type determination of step 106. For example, a first product may be determined as a “high risk” commodity given the inclusion of a component in a “high risk” category (such as a varnish component), and the algorithm may therefore generate a focused survey for distribution only to the varnish component supplier for expedited determination of the presence of PBTs in the first product. Also, and/or concurrently, a second product may not be constructed of any “high risk” components, and the algorithm may therefore generate a comprehensive set of surveys for transmission to multiple suppliers requesting PBT data on its respective components. In other examples, surveys directed to “high risk” part suppliers may be fast-tracked or prioritized relative to surveys directed to lower or standard risk part suppliers.

In each case, a survey may request structured data in a series of fields labeled with structured metadata describing field contents and may be generated from a template that may be automatically configured by the processing element of the server of the downstream production entity according to information generated in steps 102-108. In one or more embodiments, the survey may be configured to include instructions or specifications regarding testing protocols and/or results to aid upstream suppliers in generating and entering requested PBT data. In one or more embodiments, the survey may be populated in a user interface that includes fields for entering the Supplied Part Substance Data via a webpage for receipt of component part data from the supplier entity. In one or more embodiments, the downstream production entity may host or manage hosting of an API and/or webpage populated by a user interface configured for receiving component part data and/or Supplied Part Substance Data from the supplier entity.

Referring to step 110, the generated survey(s) may be transmitted to corresponding supplier(s) and responses may be received. In one or more embodiments, the communication element of the server of the downstream production entity may transmit the generated survey(s)—for example, via direct EDI—to communication element(s) of one or more corresponding supplier server(s). In turn, the supplier server(s) may automatically trigger orders or requests for laboratory services (whether comprising internal instructions or external/independent purchase orders) corresponding to PBT data requested regarding the part/component identified in the survey(s). Each supplier may—whether automatically or manually—enter responsive test results as structured data into a response form for the survey and transmit the same, via the corresponding communication element and server of the supplier, back to the server of the downstream production entity (including via direct EDI).

Referring to step 112, the responsive structured data may be evaluated and recorded. In one or more embodiments, the processing element of the server of the downstream production entity may execute an algorithm to determine, based on the results, whether one or more PBTs are present in corresponding parts/components. If not, the processing element may generate and store in its corresponding memory element a record including the corresponding responsive structured data and any related information showing or declaring the absence of such PBTs. If, on the other hand, PBTs are identified in the responsive structured data, the processing element of the server may optionally evaluate (again or for the first time) whether the identified PBT substance qualifies under a product exclusion (for example, under the TSCA or something similar). The processing element may further generate a list of parts/components/products that relate to (for example, are assembled with or rely on) the part(s) identified as containing PBT substance(s). Resulting records may be stored on the memory element of the server, for example in the database mapping parts and components to governmental restrictions relating to PBT substances.

Referring to step 114, production and warehouse statuses for impacted parts/components/products may be automatically altered. In one or more embodiments, the processing element of the server of the downstream production entity may utilize the list of related parts/components/products generated in step 114 to cause changes in corresponding statuses stored in warehouse and production databases of the downstream production entity based on the corresponding governmental restriction(s) mapped thereagainst in the database. For example, the processing element may identify each warehouse and production facility storing or processing each impacted part/component/product (such as by matching unique product identifiers used to track parts and components throughout each step of the exemplary process outlined herein) and may cause corresponding records managed by database management systems of corresponding warehouse and production servers to include an “on-hold” flag. In one or more embodiments, the transmissions between such servers may occur via direct EDI. However, in one or more embodiments, the various databases of the downstream production entity outlined herein may be collapsed to fewer or a single database and/or server without departing from the spirit of the present invention.

Referring to step 116, labeling instructions may be automatically generated and transmitted. In one or more embodiments, products requiring a label under applicable law (for example, the TSCA or similar statute(s) or regulation(s)) may be identified by the processing element of the server of the downstream production entity based, for example, on information contained in the data matrix relating to date of production/processing of each part/product. For example, the processing element of the server of the downstream production entity may determine, based on one or more corresponding governmental restrictions, that impacted parts/products produced/processed before a given date should receive a warning label relating to the detected PBTs and/or mitigation measures required because of the presence of the PBTs. The processing element may automatically generate instructions for generating the required label(s) and transmit same to corresponding server(s) (including warehouse or production servers) of the downstream production entity or a still further downstream production entity to which such impacted parts/products were sold. Corresponding instructions may be stored in the databases of the warehouse and production servers for execution. Once the required labels are applied, the warehouse and production servers may transmit notifications regarding the same to the processing element of the server. In turn, the processing element of the server may transmit instructions in reply that any corresponding “on-hold” flags be changed to permit further processing/distribution of the impacted parts/components/products.

### Embodiments of the Exemplary Method

As noted above, steps 102-116 may be performed in varying combinations by one or more of the computing systems of the downstream production entity(ies) and upstream supplier entity(ies) and/or, optionally, one or more still further downstream entities to which impacted parts/components/products were sold by the downstream production entity. For example, in one or more embodiments, the downstream production entity and/or a still further downstream entity may generate a structured survey or other request for Supplier Substance Data which triggers collection of such data by or via the corresponding upstream supplier entity(ies). In one or more alternative embodiments, such information request triggers may be omitted, with the upstream supplier entity(ies) being alternatively moved toward and/or autonomously collecting and providing the Supplier Substance Data. It is also foreseen that structured survey(s) and data request(s) may originate with and/or be revised or formulated by an upstream supplier entity without departing from the spirit of the present invention.

Moreover, it should be appreciated that steps for gathering data for, and structuring, the part/product data matrix may at least in part be performed by the computing system of the upstream part supplier and/or a still further downstream entity. In one or more embodiments, the relational database mapping Supplier Substance Data and governmental restrictions to parts, components and/or products may be structured, managed and stored by the computing system of the upstream supplier entity(ies) and, at least in part, be linked to or comprise the part/product data matrix. For example, the downstream production entity and/or the upstream supplier entity(ies) may alone or together gather statutory and/or regulatory text, extract one or more descriptions therefrom of restricted substances and corresponding parts/products, and synthesize an algorithm comprising, for example, a decision tree or complex set of business rules, or otherwise map or relate governmental restrictions on the restricted substances and the corresponding parts/products to indexed customer parts/products within the corresponding database(s).

Further, evaluation of exclusions (for example, pursuant to step 104 described above) and determination of corresponding campaign type(s) (for example, pursuant to step 106 described above), may in each case be performed by the computing system of the upstream supplier entity(ies) and/or any still further downstream entity. Such evaluation and determination may, in turn, be used to generate, configure or revise any structured survey or other requests received from the downstream production entity. That is, a request for information from the downstream production entity may be revised in view of exclusion(s) and/or campaign type(s) determined by the upstream supplier and/or any still further downstream entity in the manner described above. It is also foreseen that such information requests and/or revised requests may be transmitted in whole or in part to still further upstream supplier(s) and/or to test labs within the scope of the present invention.

In one or more embodiments, the computing system of the upstream supplier entity(ies) may likewise generate, receive, evaluate and/or record responsive structured or unstructured data, such as Supplied Substance Data, for example pursuant to step 112 described above. Such operations may directly populate the relational data base mapping Supplied Substance Data and/or governmental restrictions to parts, components and/or products.

Moreover, in one or more embodiments, the computing system of the upstream supplier entity(ies) may be responsible for flagging or otherwise detecting instances of restrictions applicable to parts or components supplied to the downstream production entity, for example wherever the Supplied Substance Data indicates same. The computing system of the upstream supplier entity(ies) may also—independently or within the same database—store descriptions of and/or instructions for generating one or more label(s) or restrictive measure(s) associated with and/or to be taken in response to occurrence of such instances. For example, wherever received and/or stored Supplied Substance Data is determined to be within the scope of a restriction applicable to one or more parts or components supplied to the downstream production entity, the computing system of the upstream supplier entity(ies) may be configured to automatically generate an electronic message including a corresponding label or restrictive measure to be taken by the downstream production entity.

Moreover, it is foreseen that the upstream supplier entity may manage user interface(s), APIs, or the like for receiving entries, requests and/or data from its downstream production entity(ies) and/or its own suppliers, as well as information from third parties relating to governmental restrictions, within the scope of the present invention to enable performance of the steps described herein.

Turning now to FIGS. 7A and 7B, embodiments of an exemplary computer-implemented method 200 for performing aspects of an interparty component supply chain control method are illustrated. In one or more embodiments, the steps of FIGS. 7A and 7B may be performed (unless otherwise indicated) by the computer system of the downstream production entity.

Referring to step 202, a downstream production entity computer system may communicate with a procurement database to access and/or load commodity information at step 206, with an engineering database to access and/or load BOM information including product information at step 208, with an inventory management and logistics database to access and/or load warehouse information and status at step 210, and with a business contact database to access and/or load current business customer information and related/corresponding products, and with any other database that includes part information to access and/or load data used to establish a commodity data matrix. Exemplary information populating the commodity data matrix may include commodity information, supplier information, BOM information, inventory information, and production planning information.

Commodity information may include one or more of a part number, customer part number, part category, part description, part group, commodity family, and a commodity code. Commodity information may be used to identify high-risk commodities to survey with supply chains in terms of potential PBT exposure. High risk commodities with the inclusion of PBT may include resin, epoxy, varnish, insulation cable, wire, and paint. Additionally, high risk commodities may be pre-selected from the data-matrix for conducting partial survey(s) to expedite survey processes. Additionally, once a PBT is identified through a supply chain survey process, part category, part description, group, commodity family and commodity code information may be used to determine whether a component part product is subject to a product exclusion designated by the Environmental Protection Agency (“EPA”) under TSCA (if subject to an exclusion, a business may be permitted continued use of such a component/part/product, for example, in its finished good(s), at least for a limited period). One of ordinary skill will appreciate that references herein to the EPA, TSCA and other entities, statutes and/or regulations are merely exemplary, and that other agencies, entities, statutory and/or regulatory schemes may be readily utilized in connection with embodiments of the present invention. Similarly, references to “PBT” substances are merely exemplary, and any other restricted substance category may be defined for use in connection with embodiments of the present invention.

Supplier information may be used to establish contact information for suppliers for the conduct of survey(s) focusing on risks flowing from governmental restrictions, such as EPA TSCA survey(s). Data universal numbering system (DUNS) code may be used to verify the identity and legitimacy of a supplier.

BOM information may, in some embodiments, be used by a downstream production entity monitoring module to map components/parts to finished goods or products, which helps to bridge part survey results to products and enable actions pertaining to governmental restrictions. In one or more embodiments, the downstream production entity monitoring module may monitor transmissions received from a supplier entity and use such transmissions to implement action(s) responsive to a governmental restriction linked to a corresponding component or product. The governmental restriction may comprise or be embodied within, for example, a list of rules mapping restricted substances to required or recommended actions. The actions may be taken on or relative to the implicated component part or product. The substance contained in the component part or product may be a corresponding one of the restricted substances.

A specific component/part data matrix may be accessed in order to access a bill of material. By storing data associated to part level compliance information, a product level compliance evaluation can be achieved. BOM information is also leveraged to meet EPA TSCA labelling requirements if a PBT is identified in a product. Customer contact information and related product information may be used to establish communication between involved entities in connection with fulfilling legal notification requirements.

Inventory information may be used to enable containment and mitigation actions on inventory after a PBT is identified. Software of embodiments of the present invention immediately notifies business stakeholder(s) that there is a TSCA compliance risk with respect to affected inventory, and such inventory can be put on “on-hold” status until further business decisions are made regarding the affected inventory.

Production planning information may be used to perform corrective actions within a production plant. In one or more embodiments, corrective actions may be implemented in part by the downstream production entity and/or by a computer system operating on behalf of a further downstream entity. Once a PBT is identified, a warning or production on-hold status will be sent out to production stakeholder(s) to mitigate or prevent a potential compliance risk.

In an embodiment of the present invention, mitigative or preventative actions can include several corrective responses if a PBT is found in the Supplied Part Substance Data. For example, the action may include—based at least in on the BOM information, inventory information, or production planning information—generating a label and/or instructions and applying the label and/or instructions on the implicated component part and/or a device or product including the component part wherever the component part and/or device are distributed in a geographical territory subject to the governmental restriction(s). In another example, the action may include terminating distribution of the component part and/or device in the geographical territory. Such termination may, for example, be triggered based on determination that a use to which the component part or product is put is not permitted under a governmental restriction. In still another example, the action may include terminating distribution of the component part and/or device in the geographical territory wherever the component part and/or device is manufactured illegally in the geographical territory.

Returning to FIG. 7A, at step 214 a relevance check may be performed at least in party by filtering customer information. At step 216, software of embodiments of the present invention determines whether a product will access an implicated geographic market (for example, the United States market). If it is determined that the product will access the United States market, the software determines, at step 218, whether the product will be used for excluded purposes, such as, for example, research & development (R&D), defense, and/or homeland security purposes. If it is determined that the product will be used for an excluded purpose, the product may, at step 220, be excluded from further compliance checks according to embodiments of the present invention because, in the working example, products that will be used for R&D, defense or homeland security purposes are not regulated under the EPA TSCA. Furthermore, products that will not access the implicated geographic market (such as, in the example, the United States market) may also be excluded at step 220, for example because the EPA TSCA regulates only the United States market.

It should be understood by one skilled in the art that similar bodies of law exist for markets outside of the United States market, and the corresponding relevance checks may, in embodiments of the present invention, be adapted to the provisions of such bodies of law to achieve similar results for such outside markets. It should further be understood that the commodity data matrix may be configured or used to exclude such components/products from compliance checks and mitigation measures, for example so that corresponding surveys need not be sent out to entities in order to update the data matrix.

Referring to step 222 and in connection with description of the commodity information above, a campaign decision on what type of campaign to engage in (for example, a partial or full survey) may be made. Embodiments of the present invention allow for different types of campaigns. For example, a full campaign may be a larger survey inquiry to supply chain customers, whereas a partial campaign may be directed to high-risk parts/commodities.

In one or more embodiments, the type of campaign may be determined based at least in part on risk level as well as operating resources and expected lead-time to engage in the material compliance and data gathering/assessment processes. At step 224, the software determines whether to make a full or partial campaign. At step 226, the software may screen out high-risk commodities that may contain the PBT based on the category of commodity stored in the data matrix and flag corresponding products/components for more focused partial campaigns that may enable quicker and more efficient identification of components including PBTs.

Referring to step 228, the software may finalize survey information by verifying part/supplier information at step 230 and, in one or more embodiments, finalize a survey template at step 232. For example, a survey template may be designed around the EPA TSCA but can also be designed for the law of another locality. At step 234, the software may be used to trial/debug internally to evaluate if survey feedback and communication mechanisms between different customers work as required. At step 236, the survey(s) may be sent out to designated suppliers of components/parts.

Turning to FIG. 7B, a survey supply chain process 238 for conducting and evaluating supply chain surveys among suppliers of components/parts is illustrated. At step 240, a determination may be made as to whether a response has been received from a surveyed supplier. If a response has not been received, at step 242, an automated follow-up may be sent, and a subsequent check for whether a response was received may be performed at step 244. In one or more embodiments, the process may include one or more additional follow-ups. For example, the follow-ups may rely on a pre-determined escalation process (for example, where a first follow-up automatically goes to a lower level of supplier management, and a second follow-up after a pre-determined period of time goes to a higher level of supplier management). In one or more embodiments, if a response is not received to the follow-up described at step 242, then an escalated follow-up survey may be sent at step 246. Another check may be conducted to determine if a corresponding response was received at step 248. If a response was received, then a confirmation of receipt message is sent to the supplier at step 250 to confirm the receipt of the results of the survey. However, if a response is still not received, then, at step 252, an escalated message may be sent to a business commodity stakeholder and/or to legal dispute counsel of the supplier. Legal disputes may be instituted to bring business attention to a compliance risk. The time and frequency of the survey and follow up(s) are flexible and may be adjusted within the software.

Referring to step 254, a process to record survey results is conducted. At step 256, when a survey result is received, the program according to embodiments of the present invention will review the supplier survey response by automatically extracting information out of the survey response regarding the presence and concentration (for example, weight-by-weight percentage or showing as parts per million (“PPM”)) of PBT substance(s) in corresponding supplier components or parts. The software or program may also engage or assign a status tracker to take one or more actions based on such extracted information.

Referring to step 258, it may also be determined whether there is any PBT substance (as per TSCA regulation) present within the component(s) or part(s) reflected in the survey results. If a PBT substance was reported in the survey results, the program may, at step 260, compare the corresponding component/part information with a commodity category/code. At step 262, the program may identify if the substance falls under a product exclusion list based at least in part on the comparison at step 260. A product exclusion list may relieve a component or part from the need for mitigative or corrective action that otherwise might be required under a governmental restriction, under applicable law. For example, a full product exclusion list per the EPA TSCA on five (5) PBTs can be found at Persistent, Bioaccumulative, and Toxic (PBT) Chemicals under TSCA Section 6(h). In an exemplary use of a TSCA product exclusion, a bearing lubricant at a part level that contains phenol, isopropylated phosphate 3:1 (PIP) may be identified in the survey results. There may be a product exclusion defined under the law that excludes PIPs substances where “[p]rocessing and distribution [is] for use in lubricant and greases.” Considering this provision, even though such a bearing lubricant contains PIP, the lubricant is still allowed to be used in lubricant and is therefore in-compliance with the EPA TSCA.

Such an exclusion may be automatically determined by the software, and stored in connection with the corresponding component(s) or part(s). For example, if the component, part or product falls under the product exclusion list, the program may update a corresponding data matrix tracker with a TSCA compliant-indicator and mark the data tracker as compliant with the TSCA at step 264. Moreover, the supplier survey response may be uploaded onto a data server at step 266, alone or together with a declaration file. At step 268, the file may be saved to complete the survey process and the compliance file may be saved on the server (for example, for a compliance period such as for three (3) years or as long as required to maintain compliance with the EPA legal obligation(s) with respect to record keeping).

Referring back to step 262, if the product does not fall under the product exclusion list, the program will generate the list of impacted parts/products at step 272, save the EPA TSCA file on the server at step 274 (similar to step 268), and, at step 276, use the file as an input for a subsequent process.

The process to record the survey results ends at step 270.

Turning now to FIGS. 8A and 8B, an exemplary computer-implemented method 300 for performing aspects of an interparty component supply chain control method are illustrated. In one or more embodiments, the steps of FIGS. 8A and 8B may be performed (unless otherwise indicated) by the computer system of the downstream production entity.

Where a PBT substance is identified at a part/component level and used on a finished good or product, and there is no provisional product exclusion applicable to the part, a corrective action may be mandated to mitigate compliance risk. Referring to step 302, a part/product list including those parts/components and corresponding products is generated for use in containment and risk assessment throughout method 300. As illustrated in FIG. 8A, containment and risk assessment processes may proceed in parallel and be bifurcated along two (2) paths.

In one or more embodiments, and referring to steps 304 and 306, data server communication with two (2) separate databases may be established to collect information for containment. In the illustrated example, the two (2) databases may respectively be directed to the storage of information relating to production planning and warehouse/logistical status. In the examples described in preceding sections, these databases may respectively be managed by third and fourth computing systems operating on behalf of a downstream production entity or a further downstream entity.

Referring to steps 308 and 310, planning statuses and inventory statuses (for example, where products including a flagged part/component are already built and are on-hand at warehouse(s)) are respectively loaded or accessed for the affected products. Referring to steps 312 and 314, planning and inventory statuses may respectively be updated with “on-hold” or similar designations, flags or statuses in the planning and warehouse/logistical databases. For example, in step 312, production planning information and database entries may be accessed for the affected product/part/component and in-route/scheduled production processes, and corresponding data fields may be populated or associated with an “on-hold” mark-up status. For another example, in step 314, based on BOM information, corresponding data fields reflecting affected inventory status may be associated with an “on-hold” mark-up status as well.

After warehouse and production statuses have been successfully updated in connection with steps 312, 314, a summary of risk assessment may be generated at step 316. The summary of risk assessment may describe the affected quantity of products and impact to production. Referring to step 318, the summary may be sent out or transmitted to one or more business stakeholders, for example those involved in engineering, operation, production planning and/or material compliance processes/personnel matters.

Turning now to FIG. 8B, a reaction or corrective/mitigative action process 320 is conducted. In the illustrated example, the EPA TSCA legal framework provides the governmental restrictions and substance definitions underpinning the process 320. Pursuant to process 320, supply chain actors (irrespective of position) may: (I) prohibit the distribution of PBT substance and product(s)/component(s) in which it is contained; (II) notify downstream customer(s) and entities to prohibit further distribution of affected product(s)/component(s); (III) add “prohibition on release to water” on SOS or product label(s); and/or (IV) keep compliance records for three (3) years subject to EPA audit. The software program may be hosted on a server (for example, operated on behalf of a downstream production entity or further downstream entity), and may comprise a centralized platform to keep a trackable record of TSCA compliance information.

Referring to step 322, it may be determined whether current inventory of affected product was manufactured/processed before or after a critical date or another applicable line derived from an applicable statute/regulation (for example, as defined in EPA TSCA section 6(h)). Additional information may be acquired or loaded to support such a determination, such as a manufacturing (MFG) date code or a data matrix label (1O or 2O bar code).

If the product was manufactured after such a date (depicted as Mar. 8, 2021 in FIG. 8B), then, at step 324, the “on-hold” status both at the production and warehouse database locations/levels will be maintained until further business action because the affected product/component is/are considered non-compliant to further distribute, process or manufacture under applicable regulations (for example, per the EPA TSCA regulation). The reaction process would then end at step 326.

If, instead, the product was manufactured before the critical date, at step 328 a legal notification may be sent to affected customers (for example, as determined from data matrix and BOM information). The notification may, for example, notify the customer regarding prohibition on the distribution of such affected product/component and/or confirm PBT substance presence within such affected product/component.

In addition to legal notifications to downstream customer(s), based on the compliance data, at step 330 an EPA TSCA warning label(s) may be generated and/or transmitted by the determining computing system (for example, the system of the downstream production entity or a further downstream entity) for storage in internal stakeholder databases (for example, those operated by or on behalf of internal warehouse and production plant facilities). Such stakeholders may apply the stored label(s) and, at step 332, such application may be confirmed (for example, through data entry to such database(s)).

Once label application actions have been taken and confirmed for products manufactured before the critical date, the affected product may, at step 334, be marked as “TSCA compliant,” or the like, in the corresponding data matrix tracker. By successfully adding warning labels, such product and any subsequent product may, at step 336, be released from inventory at the warehouse and/or from production hold(s).

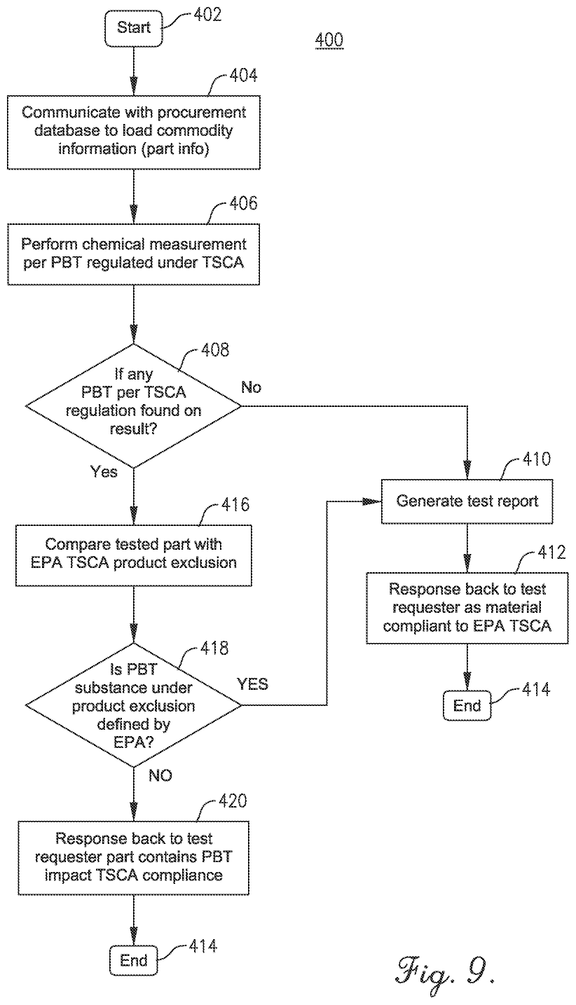

Turning now to FIG. 9, chemical testing for PBTs may be conducted by independent laboratories and/or suppliers (for example, in response to and to enable completion of survey requests described above) and/or by a downstream receiving entity (for example, an entity sending such survey requests). Such processes may integrate EPA TSCA chemical identification with testing equipment to bridge the gap between a testing result and material compliance. This may help bring about early business awareness before a product is released or a product undergoes a new product development stage. It may also add additional value to new or existing chemical measurement equipment. An exemplary process flow 400 for this is shown in FIG. 9.

Referring to step 404, the starting point of a chemical test may be to access or load test sample information, such as part information accessed from the part data matrix.

Referring to step 406, a chemical content test may be performed with testing equipment to determine the presence of any restricted substance, such as any one of at least five (5) PBTs. The testing equipment may, in one or more embodiments, implement one or more of the following protocols: inductively coupled plasma optical emission spectrometry (ICP-OES), gas chromatography-mass spectrometry (GC-MS), ultraviolet visible spectroscopy (UV-Vis), high-performance liquid chromatography (HPLC) and flame ionization detector (GC-FID).

Based on results of the chemical test, a determination may, at step 408, be made as to whether PBT substance(s) have been identified. If no PBT substances are identified, the program may, at step 410, generate a test report indicating that the tested part is compliant with the EPA TSCA. The test report may, at step 412, be sent back to the test initiator (for example, a supplier or downstream production entity).

Referring to step 416, if the results of the chemical test instead indicate that a PBT substance was present in the part under examination, the part may be compared against EPA TSCA product exclusions (as explained previously in exclusion determination section(s)). Referring to step 418, it may be determined whether the PBT substance falls under a product exclusion as defined by the EPA. If the tested sample falls under such a product exclusion, the process may continue to steps 410, 412, and 414, as described above, with corresponding results and determinations being reflected in such a test report. If, however, the measured sample containing PBT substance does not fall under a product exclusion, a response, at step 420, may be sent back to the test requester confirming the presence of PBT substances and/or indicating a non-excluded status for the part(s), which may impact product compliance under the EPA TSCA as outlined above.

The methods herein may include additional, less, or alternate steps and/or device(s), including those discussed elsewhere herein.

### Additional Considerations

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claim set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although consumer operations of one or more methods are illustrated and described as separate operations, one or more of the consumer operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (such as code embodied on a machine-readable medium or in a transmission signal) or hardware. In hardware, the routines, etc., are tangible units capable of performing certain operations and may be configured or arranged in a certain manner. In example embodiments, one or more computer systems (such as a standalone, client or server computer system) or one or more hardware modules of a computer system (such as a processor or a group of processors) may be configured by software (such as an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (such as encompassed within a general-purpose processor or other programmable processor) that is temporarily configured by software to perform certain operations. It will be appreciated that the decision to implement the processing element as special purpose, in dedicated and permanently configured circuitry, or as general purpose (such as configured by software) may be driven by cost and time considerations.

Accordingly, the term “processing element” or equivalents should be understood to encompass a tangible entity, be that an entity that is physically constructed, permanently configured (such as hardwired), or temporarily configured (such as programmed) to operate in a certain manner or to perform certain operations described herein. Considering embodiments in which the processing element is temporarily configured, each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (for example, over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices and may operate on a resource (such as a collection of information).

The various operations of example methods described herein may be performed, at least partially, by one or more processing elements that are temporarily configured (for example, by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (such as within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (such as a computer with a processing element and other computer hardware components) that manipulates or transforms data represented as physical (including electronic, magnetic, or optical) quantities within one or more memories (including volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claim at the end of this patent application is not intended to be construed under 35 U.S.C. § 112(f) unless traditional means-plus-function language is expressly recited, such as “means for” or “step for” language being explicitly recited in the claim.

Although the invention has been described with reference to the embodiments illustrated in the attached drawing figures, it is noted that equivalents may be employed, and substitutions made herein without departing from the scope of the invention as recited in the claims.

Having thus described various embodiments of the invention, what is claimed as new and desired to be protected by Letters Patent includes the following:

We claim:

1. A computer-implemented method for interparty component supply chain control comprising, via one or more transceivers and/or processors:
accessing, at a computing system operated on behalf of a downstream production entity, a database containing supplied part substance data relating a substance contained in a component part to a governmental restriction;
generating, at the computing system of the downstream production entity, an electronic message describing performance of an action by a further downstream entity to be taken on or relative to the component part based on the governmental restriction; and
transmitting the electronic message to a computing system operated on behalf of the further downstream entity.

2. The computer-implemented method of claim 1, further comprising, via the one or more transceivers and/or processors:
receiving, at the computing system of the downstream production entity, one or more of a request for data from the database and a request for laboratory testing of the component part.

3. The computer-implemented method of claim 2, further comprising, via the one or more transceivers and/or processors:
receiving, at the computing system of the downstream production entity and in response to one or more of the request for data from the database and the request for laboratory testing of the component part, the supplied part substance data from a computing system operated on behalf of a supplier entity.

4. The computer-implemented method of claim 3, wherein the supplied part substance data is obtained by populating, via the computing system operated on behalf of the downstream production entity, a survey template to create a survey and transmitting the survey to the computing system operated on behalf of the supplier entity, the survey being generated based at least in part on designation of the component part as a “high risk” commodity.

5. The computer-implemented method of claim 3, wherein the supplied part substance data is obtained by populating a user interface via a webpage for receipt of component part data from the supplier entity.

6. The computer-implemented method of claim 1, wherein the action comprises one or more of the following:
(i) applying a label to at least one of the component part and a device including the component part;
(ii) terminating distribution of at least one of the component part and the device including the component part within a geographical territory.

7. The computer-implemented method of claim 6, further comprising, via the one or more transceivers and/or processors:
monitoring, via a downstream production entity monitoring module, a database entry of the database corresponding to the component part;
detecting a change in the database entry responsive to receipt of a transmission from a computing system operated on behalf of a supplier entity, the transmission including information relating the component part to the substance, wherein the electronic message is generated based at least in part on the detected change.

8. The computer-implemented method of claim 7, further comprising, via the one or more transceivers and/or processors:
mapping, via a data management system of the computing system operated on behalf of the downstream production entity, the information relating the component part to the substance to the governmental restriction in the database.

9. The computer-implemented method of claim 8, wherein the data management system is configured to store the mapped relationship in association with a plurality of corresponding unique part identifiers, the unique part identifiers including a first unique part identifier corresponding to the component part.

10. The computer-implemented method of claim 1, wherein the electronic message describing the action is based on a determination of whether the substance and the component part are subject to an exclusion.

11. A non-transitory computer-readable storage media having computer-executable instructions stored thereon for interparty component supply chain control, wherein when executed by at least one processor the computer-executable instructions cause the at least one processor to:
access, at a computing system operated on behalf of a downstream production entity, a database containing supplied part substance data relating a substance contained in a component part to a governmental restriction;
generate, at the computing system of the downstream production entity, an electronic message describing performance of an action by a further downstream entity to be taken on or relative to the component part based on the governmental restriction; and
transmit the electronic message to a computing system operated on behalf of the further downstream entity.

12. The non-transitory computer-readable storage media of claim 11, wherein the computer-executable instructions further cause the at least one processor to:
receive, at the computing system of the downstream production entity, one or more of a request for data from the database and a request for laboratory testing of the component part.

13. The non-transitory computer-readable storage media of claim 12, wherein the computer-executable instructions further cause the at least one processor to:
receive, at the computing system of the downstream production entity and in response to one or more of the request for data from the database and the request for laboratory testing of the component part, the supplied part substance data from a computing system operated on behalf of a supplier entity.

14. The non-transitory computer-readable storage media of claim 13, wherein the supplied part substance data is obtained by populating, via the computing system operated on behalf of the downstream production entity, a survey template to create a survey and transmitting the survey to the computing system operated on behalf of the supplier entity, the survey being generated based at least in part on designation of the component part as a “high risk” commodity.

15. The non-transitory computer-readable storage media of claim 13, wherein the supplied part substance data is obtained by populating a user interface via a webpage for receipt of component part data from the supplier entity.

16. The non-transitory computer-readable storage media of claim 11, wherein the action comprises one or more of the following:
(i) applying a label to at least one of the component part and a device including the component part;
(ii) terminating distribution of at least one of the component part and the device including the component part within a geographical territory.

17. The non-transitory computer-readable storage media of claim 16, wherein the computer-executable instructions further cause the at least one processor to:
monitor, via a downstream production entity monitoring module, a database entry of the database corresponding to the component part;
detect a change in the database entry responsive to receipt of a transmission from a computing system operated on behalf of a supplier entity, the transmission including information relating the component part to the substance, wherein the electronic message is generated based at least in part on the detected change.

18. The non-transitory computer-readable storage media of claim 17, wherein the computer-executable instructions further cause the at least one processor to:
map, via a data management system of the computing system operated on behalf of the downstream production entity, the information relating the component part to the substance to the governmental restriction in the database.

19. The non-transitory computer-readable storage media of claim 18, wherein the data management system is configured to store the mapped relationship in association with a plurality of corresponding unique part identifiers, the unique part identifiers including a first unique part identifier corresponding to the component part.

20. The non-transitory computer-readable storage media of claim 11, wherein the electronic message describing the action is based on a determination of whether the substance and the component part are subject to an exclusion.
